(19) United States
(12) Patent Application Publication
(10) Pub. No.: US 2019/0317835 A1
(43) Pub. Date: Oct. 17, 2019

(54) MANAGEMENT OF EVENTS IN EVENT MANAGEMENT SYSTEMS

(71) Applicant: INTERNATIONAL BUSINESS MACHINES CORPORATION, Armonk, NY (US)

(72) Inventors: Paul B. French, Cork (IE); Gerd Breiter, Wildberg (DE); Kristian J. Stewart, Surrey (GB); John Lee, Petaling Jaya (MY)

(21) Appl. No.: 15/951,247

(22) Filed: Apr. 12, 2018

(51) Int. Cl. G06F 9/54; G06F 17/30

(52) U.S. Cl. CPC G06F 9/542; G06F 17/30914; G06F 17/30604; G06F 17/30292

(57) ABSTRACT

A system, method and computer program product are provided for improved management of events. A plurality of events is received from an event source. Each event comprises event data relating to a monitored system associated with the event source. A set of data fields in the event data of the plurality of events is identified. One or more relationships between at least one data field in the set of data fields and at least one other data field in the set of data fields are determined. A mapping of the event data of the plurality of events to a predefined common format is determined, based on the one or more relationships.

### BACKGROUND

The present disclosure relates to systems management, and, more specifically, to methods for the management of notifications and events from multiple sources in an event management system.

### SUMMARY

According to an aspect of the present disclosure, a computer implemented method is provided. A plurality of events is received from an event source. Each event comprises event data relating to a monitored system associated with the event source. A set of data fields in the event data of the plurality of events is identified. One or more relationships between at least one data field in the set of data fields and at least one other data field in the set of data fields are determined. A mapping of the event data of the plurality of events to a predefined common format is determined, based on the one or more relationships.

According to another aspect of the present disclosure, an apparatus is provided. The apparatus comprises an event learning system. The event learning system comprises a processor and memory. The processor is configured to receive a plurality of events from an event source. Each event comprises event data relating to a monitored system associated with the event source. The processor is further configured to identify a set of data fields in the event data of the plurality of events. The processor is configured to determine one or more relationships between at least one data field in the set of data fields and at least one other data field in the set of data fields. The processor is further configured to determine a mapping of the event data of the plurality of events to a predefined common format, based on the one or more relationships.

According to yet another aspect of the present disclosure, an apparatus is provided. The apparatus comprises an event management system. The event management system comprises a validator for validating events received from an event source according to a corresponding events model. The event management system further comprises a normalizer for mapping event data of validated events received from the event source to a predefined common format according a mapping for the event source. The mapping is determined by an event learning system in accordance with the preceding aspect of the present disclosure.

According to still another aspect of the present disclosure, a computer program product is provided. The computer program product comprises a computer readable storage medium having program instructions embodied therewith. The program instructions are executable by a processor to cause the processor to: receive a plurality of events from an event source, each event comprising event data relating to a monitored system associated with the event source; identify a set of data fields in the event data of the plurality of events; determine one or more relationships between at least one data field in the set of data fields and at least one other data field in the set of data fields, and determine a mapping of the event data of the plurality of events to a predefined common format, based on the one or more relationships.

According to a further aspect of the present disclosure, a computer implemented method is provided. An initial mapping of event data of at least one event received from an event source to a predefined common format is determined. Each event comprises event data relating to a monitored system associated with the event source. A normalizer is deployed in an event management system. The normalizer is configured to implement the initial mapping of the event data to the predefined common format for events received by the event management system from the event source.

### BRIEF DESCRIPTION OF THE SEVERAL VIEWS OF THE DRAWINGS

Example implementations of the present disclosure will be described below with reference to the following drawings, in which:

FIG. 1 is a schematic block diagram of an operating environment comprising a system in accordance with example implementations of the present disclosure;

FIG. 2 is a flowchart of a method of event learning, in accordance with example implementations of the present disclosure;

FIG. 3 shows anchor field relationship analysis of events for use in the method of FIG. 2, in accordance with an illustrative example;

FIG. 4 shows anchor field to sub-anchor field relationship analysis of events for use in the method of FIG. 2, in accordance with the illustrative example;

FIG. 5 shows observed relationships generated by the method of FIG. 2, in accordance with the illustrative example;

FIG. 6 is a flowchart of a method of mapping observed relationships to a common format, in accordance with example implementations of the present disclosure;

FIG. 7 illustrates the mapping of the observed relationships of FIG. 5 to a common format, in accordance with the illustrative example;

FIG. 8 is a flowchart of a method of deploying a mapping for an event normalizer, in accordance with example implementations of the present disclosure;

FIG. 9 is a schematic block diagram showing the deployment of a mapping for an event normalizer, in accordance with example implementations of the present disclosure, and

FIG. 10 is a block diagram of a system, in accordance with example implementations of the present disclosure.

### DETAILED DESCRIPTION

In the field of systems management, event management systems are commonly used to manage events and notifications relating to the operations and/or performance of a monitored system. In some implementations, an event management system may be used as a “manager of managers” to manage the operations and/or performance of multiple different systems in one place. In particular, an event management system may receive events or notifications relating to the operation and/or performance of multiple different systems. Each system is typically monitored by an associated monitoring system or “event source”, which generates notifications and events relating to the operations and/or performance of the system and sends them to the event management system. Each event source provides events and notifications in a different format, which is specific to the individual requirements of the system it monitors. Accordingly, the event management system includes a so-called “normalizer” for each event source. The normalizer maps or “normalizes” events and notifications received from the corresponding event sources to a common format (e.g., a format using the same logical data structure). The event management system may also process received events and notifications, for example using filtering, data analysis and the like, prior to presenting the notifications and events to the user in the common format as incident reports and the like. By presenting notifications and events from multiple different sources in a common format, the event management system does not require users to have knowledge or expertise in each of the multiple systems/event sources, and corresponding event and notification formats. Thus, users of the event management system can adopt a consistent approach to managing the multiple systems.

A problem associated with a conventional event management system is that it is necessary to independently develop a normalizer for each individual event source or event source type. Thus, when a new event source is to be added, it is first necessary to develop an associated normalizer for use by the event management system. This requires considerable in-depth analysis of the different types of notifications and events generated by the new event source to determine a mapping to the common format. In particular, a mapping between a data parameter in events from the new event source to a particular data field of the common format may require (i) the identification of correspondence or equivalence between that data parameter and the particular data field, and/or (ii) the determination of a mapping rule or algorithm to map or normalize the data parameter to the common format. At least part of this process is performed manually, and the normalizer developer typically relies on documentation for the event source, which is sometimes inaccurate. Accordingly, the process of developing a normalizer for an event source is time-consuming and may be inaccurate.

The present disclosure provides methods, systems and computer program products for developing a normalizer for an event management system. The normalizer maps or “normalizes” event data, such as an event, notification or other operations or performance-related information, received from an event source to a defined common format for the event management system. In example implementations, the normalizer maps data parameters or fields of events and notifications from the event source to data parameters or fields of a predefined common format. The event management system uses the common format to process and present event data from multiple different event sources.

In the present disclosure, the term “event data” encompasses data relating to the operations and/or performance of a system, including, but not limited to, events, notifications, reports and the like generated by monitoring the system. The term “event” or “event message” encompasses any type of message (or similar self-contained data structure) communicating event data in its payload, including events, notifications, reports and the like. The term “event source” encompasses any system or process that provides events and event data for a system. For example, an event source may be a monitoring system that monitors the operations and/or performance of a system, and generates event messages comprising event data in the form of events, notifications, reports and the like relating to the operations and/or performance of the system. As the skilled person will appreciate, the event source may also be the monitored system itself. The term “event management system” encompasses any system or process that receives and processes event messages comprising event data from multiple different event sources. For example, an event management system may function as a “manager of managers” to provide a common system, platform and/or interface for a user to manage the operations and/or performance of multiple different systems. The term “normalizer” encompasses any system or process for use by an event management system to map, adapt or otherwise “normalize” events and event data received from a particular event source to a common predefined format. The term “mapping” encompasses the process (when used as a verb) and the rule set (when used as a noun) for converting, adapting and/or normalizing events and event data received from a particular event source to a common predefined format.

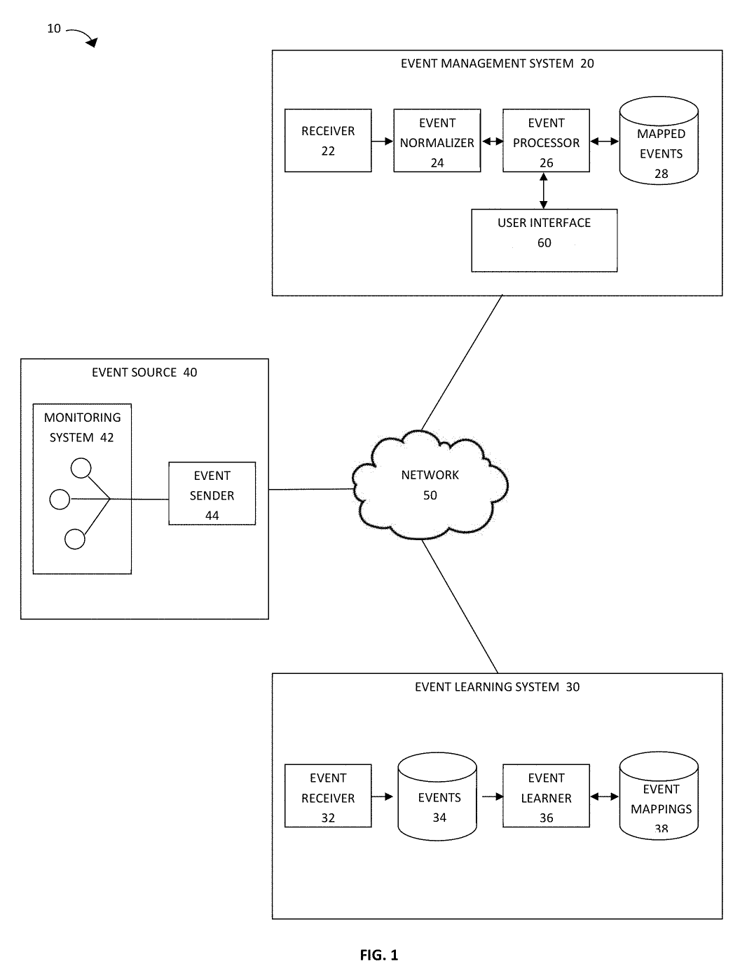

FIG. 1 shows an operating environment comprising a system 10 in accordance with example implementations of the present disclosure. In particular, the system 10 comprises an event management system 20, an event learning system 30 and at least one event source 40, interconnected by a data communications network 50.

As shown in FIG. 1, each event source 40 (only one of which is shown for ease of illustration) comprises a monitoring system 42, which detects event and notification conditions and generates event messages as described above, and an event sender 44, which sends event messages to the event management system 20 and event learning system 30 over network 50.

Event management system 20 comprises a data processing system having a processor and memory. As shown in FIG. 1, event management system 20 includes a receiver 22, an event normalizer 24, an event processor 26, and a mapped events database 28. In addition, a user interface 60 is associated with the event management system 20. User interface 60 may be integrated within the event management system 20 as shown in FIG. 1 or may be remote therefrom (e.g., within another device connected to network 50). Generally, receiver 22 of event management system 20 receives event messages comprising event data, in the form of events, notifications and the like, from the event source 40 over the network 50. Event normalizer 24 normalizes the received event data in accordance with a common predefined format. In particular, event processor 26 implements the mapping defined by the event normalizer 24, and stores the formatted event data in mapped events database 28. Event processor 26 may perform other processing operations. For example, event processor 26 may process the formatted data prior to presentation thereof by means of user interface 60. Whilst only one event source 40 is shown in FIG. 1, in practice, multiple event sources 40 provide events messages to the event management system 20 over the network 50, and an event normalizer 24 is provided for each event source 40 or event source type. Receiver 22 of event management system 20 may receive data other than event messages over network 50, as described further below.

In accordance with the present disclosure, event learning system 30 is provided for developing and updating an event normalizer 24 of the event management system 20 for a particular event source 40. Event learning system 30 comprises a data processing system having a processor and memory. Event learning system 30 comprises an event receiver 32, an events database 34, an event learner 36, and an event mappings database 38. Generally, event receiver 32 receives events messages comprising event data from an event source 40, for example as events, notifications and the like, over the network 50, and stores the event data in events database 34. Event learner 36 analyzes the event data to determine a mapping of events from the event source 40 to a predefined common format of the event management system 20. In particular, event learner 36 analyzes the event data fields contained within events received from the event source 40, and determines a mapping of the data parameters or fields to data fields of the common format. In example implementations, the analysis performed by the event learner 36 may utilize mappings of event messages and event data for other event sources 40, previously stored in event mappings database 38. This enables existing mappings to be leveraged, and ensures consistency of mapping of events from different event sources 40 to the common format. The determined mapping is then deployed (e.g., sent over network 50) by the event learning system 30 to the event management system 20 as a new or updated event normalizer 24 for events received from the event source 40.

Event learning system 30 may operate in one of several operating modes for developing and/or updating the event normalizer 24, as described herein. In particular, in example implementations, event learning system 30 may operate in a first, “learning mode”, during which the event learning system 30 receives and analyzes events over a time period prior to deployment of an event normalizer 24 in the event management system 20. In example implementations, event learning system 30 may also operate in a second, “updating mode”, during which the event learning system 30 continues to receive and analyze event data, after deployment of an event normalizer 24 in the event management system 20, and dynamically updates the mapping by the event normalizer 24, accordingly. In further example implementations, event learning system may operate in a third, “early deployment” mode, during which an initial mapping (e.g., incomplete or coarse mapping) is determined and deployed to the event management system 20, based on limited event data received from the event source 40. Further details of the methods performed by the event learning system 30 in each of the first, second and third operating modes are provided below.

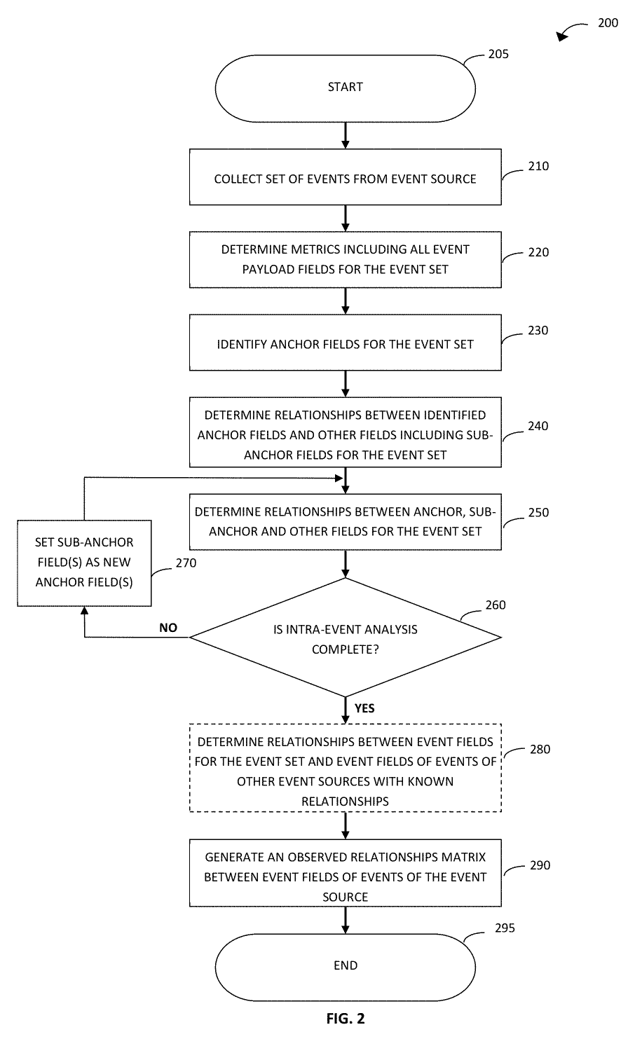

FIG. 2 is a flowchart showing a method performed by an event learning system 30 in a first mode of operation, referred to herein as the “learning mode”, in one example implementation. In accordance with conventional machine learning techniques, in the learning mode, the event learning system 30 receives and analyzes a statistically meaningful set of events comprising event data from the event source 40, in order to determine a mapping to the common format for the event management system 20 with a desired level of accuracy and robustness.

The method 200 starts at step 205. At step 210, the method collects a set of events from the event source. For example, step 210 may collect events (e.g., in the form of event messages) from the event source over a predetermined time period, or may collect events from the event source until a predetermined number of events and/or event types are obtained. The predetermined time period or the predetermined number of events and/or event types are chosen according to application requirements, typically so as to provide a statistically meaningful set of events and event data for analysis.

At step 220, the method analyzes the set of events and determines metrics for the event set. The determined metrics include the superset of all the parameters or data fields that occur in the event data in the event set (i.e., all event payload fields). Thus, the field name of each data field in the superset may be identified and analyzed. The analysis may determine metrics about the data fields in the superset, such as the frequency of occurrence of the data fields in the event set.

For example, step 220 may perform summary analysis of the event source, based on the collected set of events, and identify the following metrics:

Event source name
Collection date(s): From and To
Number of events collected
Superset of distinct fields in the event set (each field may not be present in every event)
Maximum/Minimum number of fields populated in an event
Number of events in the event set with maximum and minimum fields set
Number of common fields (i.e. 100% present)
Number of conditional or optional fields
Analysis of individual fields (Data type, range, distinct values, etc)

An illustrative example of metrics determined from a collected set of events is shown in Table 1.

TABLE 1
Summary Event Source Analysis

| | | | | Fields | | | | | | |
|---|---|---|---|---|---|---|---|---|---|---|
| Event | | | | | Maximum | # | Minimum | # | # | # |
| Source | | | # | Superset | # Fields | Events | # Fields | Events | Common | Conditional |
| Name | Date From | Date To | Events | # Fields | populated | at Max | populated | at Min | Fields | Fields |
| App | 1 Sep. 2017 | 30 Sep. 2017 | 1000 | 11 | 7 | 700 | 5 | 300 | 3 | 8 |
| Monitor | | | | | | | | | | |

In the illustrative example of Table 1, the event set collected from the event source “App Monitor” during September 2017 has 1000 events. The event set has a superset of eleven individual event payload fields (herein referred to as “fields”) represented in the events of the event set, with three common event payload fields (i.e., fields present in every individual event). The maximum number of fields populated in any individual event is seven, and the minimum number of fields populated in an individual event is five. Of the collected events in the event set, 700 events have the maximum number of fields and 300 have the minimum number of fields. Notably, according to Table 1, eight of the 11 fields are conditional fields (i.e., their presence is conditional based on a relationship to another field). The significance of conditional fields is discussed further below. As the skilled person will appreciate, conditional fields may be identified as part of the summary analysis in step 220, or during further analysis in subsequent steps of the method 200 of FIG. 2 as described below.

Based on the metrics obtained in step 220, at step 230 the method identifies the ‘key’ or significant fields in the event data of the events, in terms of management of events of the event source. In example implementations, step 230 may identify “anchor fields” (as defined further below), based on the frequency of occurrence of fields identified in the metrics from step 220. In other examples implementations, step 230 may identify other types of key fields that are significant for event management. Key fields for event management will be apparent to the skilled person and examples are described herein.

Steps 240 and 250 perform intra-event relationship analysis of the event set of the event source. In particular, each field in the events of the event set is analyzed in order to determine relationships (e.g., presence relationships due to conditions, rules and/or dependencies) between fields and fields values within events. Step 240 performs anchor field relationship analysis, and step 250 performs sub-anchor field relationship analysis (and may be repeated iteratively). The intra-event relationship analysis is an iterative process, which continues with further iterations of step 250 until all the conditions/rules for all the fields of the superset of fields of the event set are identified, as described further below.

In example implementations of the present disclosure, an anchor field is an event payload field which (i) occurs in every event, and (ii) has a limited number of distinct values (e.g., a relatively small number of possible values, for instance between two and about 10 distinct values). For example, an event source may produce event messages of two different types of event, namely alerts and notifications, each having a timestamp. Thus, the superset of payload fields identified in step 220 may include a payload field called event type with two distinct values called “alert” and “notification”, and a payload field called timestamp which has a much larger number of values corresponding to a time and date. In this example, the field event type may be considered as an anchor field, whilst the field timestamp is not. A sub-anchor field is a field which is always present in an event, when the associated anchor field has a specific value. Accordingly, a sub-anchor field is conditional on the value of the corresponding anchor field. Thus, in the above example, when the anchor field event type has the specific value “alert”, a sub-anchor field called criticality may always be present to signify the level of the alert. As the skilled person will appreciate, in other example implementations in which more complex relationships exist between data fields, anchor fields may simply have a high frequency of occurrence in all of the events, and sub-anchor fields may simply have a high frequency of occurrence in events when the anchor field has a specific value. Furthermore, in some example implementations, further event fields may be present in an event, when a sub-anchor field has a specific value. Such further event fields may be referred to as “sub-sub-anchor fields”, where the sub-sub-anchor field is conditional on the value of the corresponding sub-anchor field. As the skilled person will appreciate, for any event source, the intra-event relationships between event fields may have any number of hierarchical levels of fields comprising anchor, sub-anchor, sub-sub-anchor fields etc.

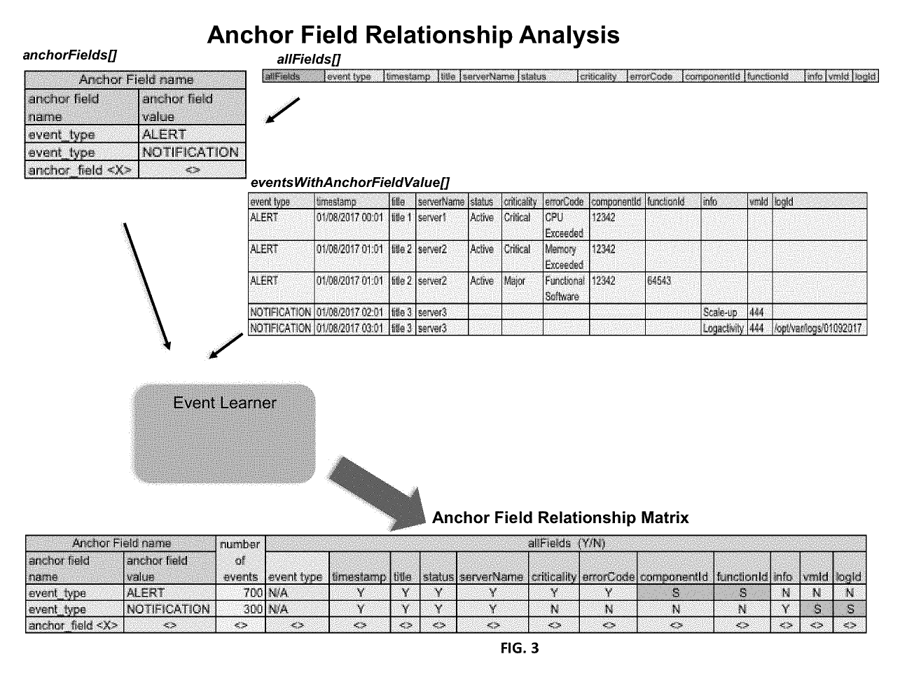

Accordingly, step 240 determines the relationships between identified anchor fields and other fields for the event set, including sub-anchor fields. For example, the relationships may be determined by analysis, based on the metrics, including the frequency of occurrence of such other fields when the anchor field has a specific value. In particular, step 240 may determine that one or more other fields in the superset are sub-anchor fields, and determine the associated condition or dependency on the anchor field and/or the value of the anchor field. For example, the analysis may consider whether each of the other fields of the superset of fields is always present, sometimes present, or never present, in events for each specific value of the anchor field and determine the associated conditions. FIG. 3 shows an example of such anchor field relationship analysis.

FIG. 3 shows the identified superset of fields (allfields[ ]) for the illustrative example. FIG. 3 also shows the identified anchor fields (anchorFields[ ]), including the example anchor field event type, which has the two possible parameter values: “ALERT” and “NOTIFICATION”. FIG. 3 shows analysis of events with the value of the anchor field event type as “ALERT” from event data (eventsWithAnchorFieldValue[ ]). In particular, FIG. 3 shows that the fields event type, timestamp, title, status, criticality and errorCode always appear (i.e., are always populated with data); the fields componentId and functionId sometimes appear (i.e., are sometimes populated with data), and the fields info vmId and logId never appear (i.e., are never populated with data) in events in which “event type” is “ALERT”. It will be appreciated that, although not shown in FIG. 3, analysis of events with the value of the anchor field event type as “NOTIFICATION” is also performed.

The analysis of events for all values of the anchor field event type (i.e., the values “ALERT and “NOTIFICATION”) produces the relationship analysis illustrated as the Anchor Field Relationship Matrix in FIG. 3. The Anchor Field Relationship Matrix represents the results of the anchor field relationship analysis of step 240, where “Y” indicates that the field is always present, “S” indicates that the field is sometimes present and “N” indicates that the field is never present. In example implementations, the presence of a field in an event may be determined when a valid value for the field is present, whilst the absence of a field may be determined when there is no valid value for the field and/or the field does not exist in the event data. As the skilled person will appreciate, in example implementations, the analysis is performed for each identified anchor field, and for each value of the anchor field.

Thus, the Anchor Field Relationship Matrix identifies, for each other (non-anchor) field, the condition or dependency of its presence on the value of the anchor field. For example, Anchor Field Relationship Matrix shows that the fields status, criticality and errorCode are sub-anchor fields of the anchor field event type and are conditional upon the rule that the value of the anchor field is “ALERT”. Note that the 3 common fields timestamp, title, status are not sub-anchor fields, whilst the other seven conditional fields are sub-anchor fields. Anchor Field Relationship Matrix also includes fields which have an “S” (i.e., componentId and functionId). The condition or dependency of the presence of a value in these fields is not apparent from the Anchor Field Relationship Matrix. Accordingly, further analysis is required to determine the conditions under which these fields will indicate a “Y” (present) or “N” (not present). This further analysis is performed in step 250.

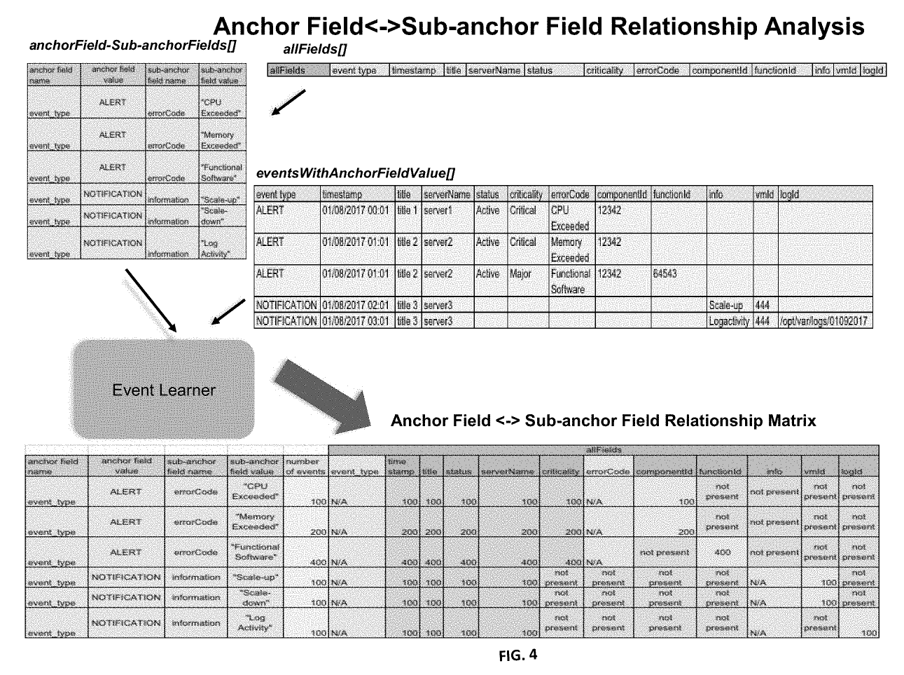

Step 250 determines the relationships between sub-anchor fields associated with each anchor field, and other fields for the event set to determine the relationships and associated conditions that are not apparent from step 240. In particular, step 250 may apply the analysis of step 240 iteratively, to each sub-anchor field identified in the Anchor Field Relationship Matrix. Step 250 may determine the relationship (e.g., presence based on frequency of occurrence) of the other fields in the superset of fields on the sub-anchor field and/or the value of the sub-anchor field. FIG. 4 shows an example of such sub-anchor field relationship analysis.

FIG. 4 shows the identified superset of fields (allfields[ ]) for the illustrative example. FIG. 4 further shows the identified sub-anchor fields of the anchor fields and their possible parameter values (anchorField-Sub-anchorFields[ ]). In particular, the anchor field event type has the sub-anchor field errorCode, when the value of event type is “ALERT”. The sub-anchor field errorCode in turn has three possible parameter values “CPU Exceeded”, “Memory Exceeded” and “Functional Software”. FIG. 4 also shows the anchor field event type has the sub-anchor field information or info, when the anchor field event type has the value “NOTIFICATION”. The sub-anchor field information in turn has three possible parameter values “Scale-up”, “Scale-down” and “Log Activity”. As the skilled person will appreciate, only a part of the sub-anchor field relationships described above are shown in FIG. 4.

FIG. 4 illustrates the iterative analysis of the sub-anchor fields of the anchor field event type, in particular the analysis of the sub-anchor field errorCode from event data (eventsWithAnchorFieldValue[ ]). In particular, FIG. 4 shows that when the sub-anchor field errorCode has the values “CPU Exceeded” or “Memory Exceeded”, the field componentId always appear (i.e., is always populated with data-equivalent to “Y” in FIG. 3) and the field functionId never appears (i.e., is never populated with data—equivalent to “N” in FIG. 3), whereas when the sub-anchor field errorCode has the value “Functional Software”, the field functionId always appears (i.e., is always populated with data—equivalent to “Y”) whereas the field componentId never appears (i.e., is never populated with data—equivalent to “N”). It will be appreciated that, although only partly shown in FIG. 4, analysis of events relating to the sub-anchor field information is also performed.

The analysis of events for all of the sub-anchor fields of the anchor field event type produces the relationship analysis illustrated as the Anchor Field <-> Sub-anchor Field Relationship Matrix in FIG. 4. The Anchor Field <-> Sub-anchor Field Relationship Matrix represents the results of the sub-anchor field relationship analysis between the anchor field event type and sub-anchor fields errorCode and information of step 250. For example, the Anchor Field <-> Sub-anchor Field Relationship Matrix shows the relationship between the sub-anchor field errorCode and each of the sub-sub-anchor fields componentId and functionId and associated condition, as described above.

At step 260, the method determines whether the intra-event analysis is complete. In particular, step 260 may determine whether all the conditions or dependencies for all the fields of the superset of fields have been identified. In example implementations, all the conditions are identified when there are no fields with an “S” (i.e., indicating that the field is sometimes present) in the Anchor Field <-> Sub-anchor Field Relationship Matrix from step 250. If step 260 determines that the intra-event analysis is complete, the method proceeds to step 280. However, if step 260 determines that the intra-event analysis is not complete, further iterative analysis is required and the method proceeds to step 270.

Step 270 sets the (previous) sub-anchor fields to the new anchor fields and returns to step 250. Thus, step 250 continues by performing sub-anchor relationship analysis on the (previous) sub-anchor fields as if they were anchor fields. Accordingly, step 250 determines the relationships between “sub-sub-anchor fields” associated with each sub-anchor field of the anchor field and other fields for the event set, in order to determine the relationships and associated conditions that are not apparent from step 250. Thus, the method iterates through deeper hierarchical levels of a relationship tree of event fields in order to identify all the relationships and associated conditions. The method continues in a loop through steps 250 to 270, until step 260 determines that the intra-event analysis is complete and proceeds to step 280.

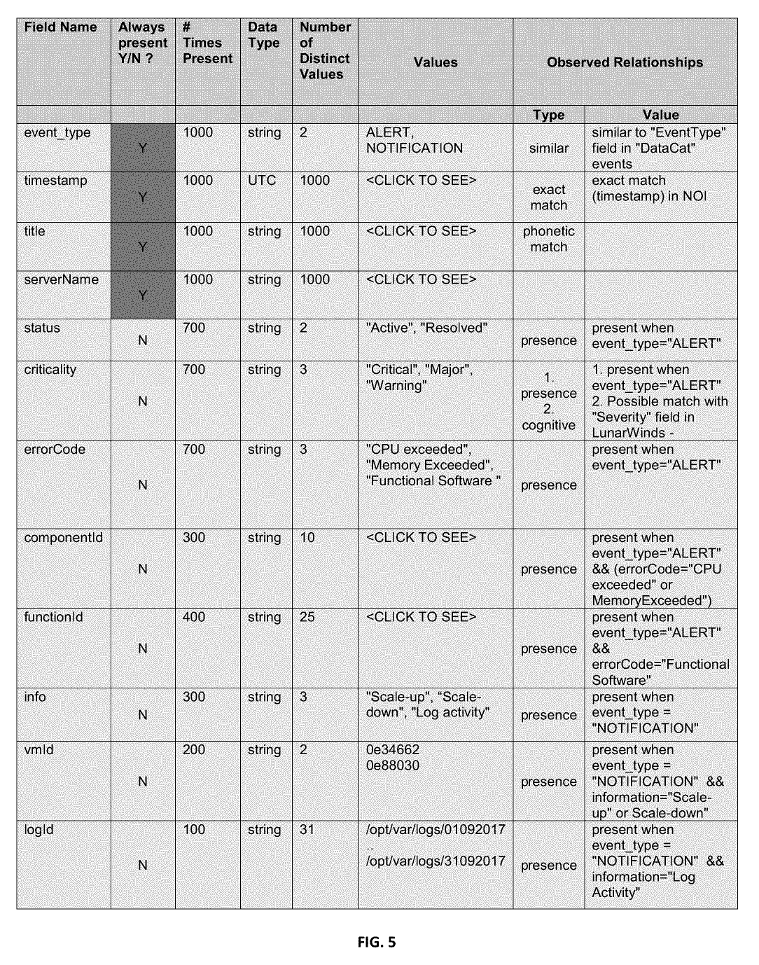

Optional step 280, performs inter-event source analysis. In particular, at step 280 the method determines relationships between event fields for the event set and event fields of events from other event sources with known relationships and/or mappings to a common format. In particular, step 280 may use previously stored data from determined relationships between event fields of events from other event sources, to mine relationships that are common within events of different event sources. Example relationships that may be considered in step 280 include: an exact match between the names or values of fields and their relationships; a similarity between the names or values of fields and their relationships, and a match (e.g., based on cognitive meaning, phonetic matching, translation matching etc.) between names or values of fields and their relationships. Step 280 may perform inter-event source relationship analysis using a suitable mining algorithm to assist in the mapping of fields of events from different event sources to the common format in the same way, to ensure consistency of mapping of fields to the common format for different event sources. The results of the analysis in step 280 may assist in the determination of the observed relationships between fields in the event set, as described below with reference to FIG. 5.

At step 290, the method generates the observed relationships, based on the analysis of the event set. In particular, step 290 may indicate the observed relationship for each field in the subset of fields for the event set, for example as an Observed Relationships Matrix between event fields of events for the event source.

FIG. 5 shows an example Observed Relationships Matrix for the fields of the superset of fields (allfields[ ]) of the set of events, for the illustrative example. In particular, the Observed Relationships Matrix indicates that the three fields event type, timestamp and title are always present in an event, and for each field, specifies “observed relationships” indicating a degree of equivalence (i.e. a level of correspondence or matching) to event fields of events from other event sources (and/or the common format). The Observed Relationships Matrix indicates that the eight other fields are not always present in an event, and for each field, specifies observed relationships indicating a degree of equivalence to event fields of events from other event sources (and/or the common format) and or other relationships, such as any inter-dependencies observed from the anchor and sub-anchor field analysis in steps 240 and 250. Following generation of the Observed Relationships Matrix in step 290, the method ends at step 295.

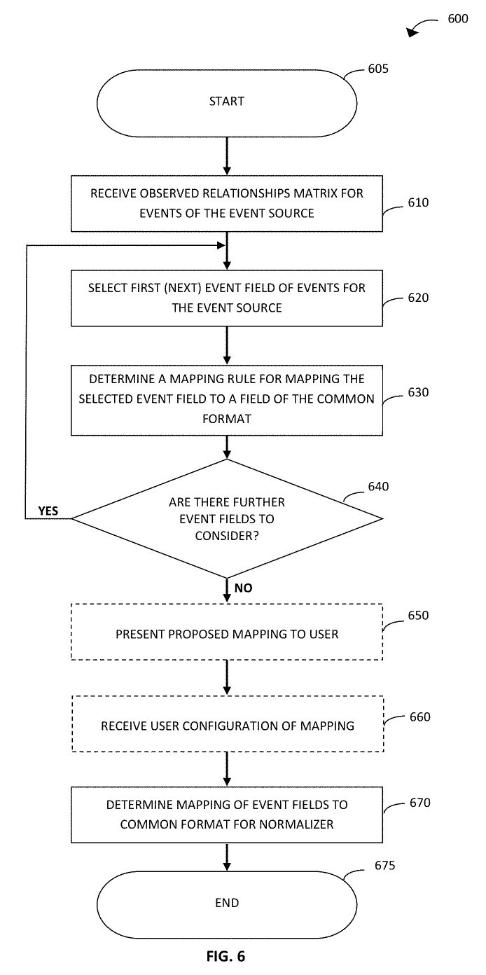

FIG. 6 is a flowchart of a method for determining a mapping performed by an event learning system 30, in accordance with example implementations of the present disclosure. In particular, the method 600 of FIG. 6 may be performed in the learning mode of the event learning system 30, following the generation of the Observed Relationships Matrix in accordance with the method of FIG. 2. The method 600 of FIG. 6 determines a mapping of the observed relationships to a predefined common format, for use by a normalizer 24 in an event management system 20. It will be appreciated that the method 600 of FIG. 6 may also be performed in the second, updating mode and the third, early deployment mode of the event learning system 30, to determine an updated or initial mapping, respectively, for deployment in a normalizer 24 for the corresponding event source 40 as described further below.

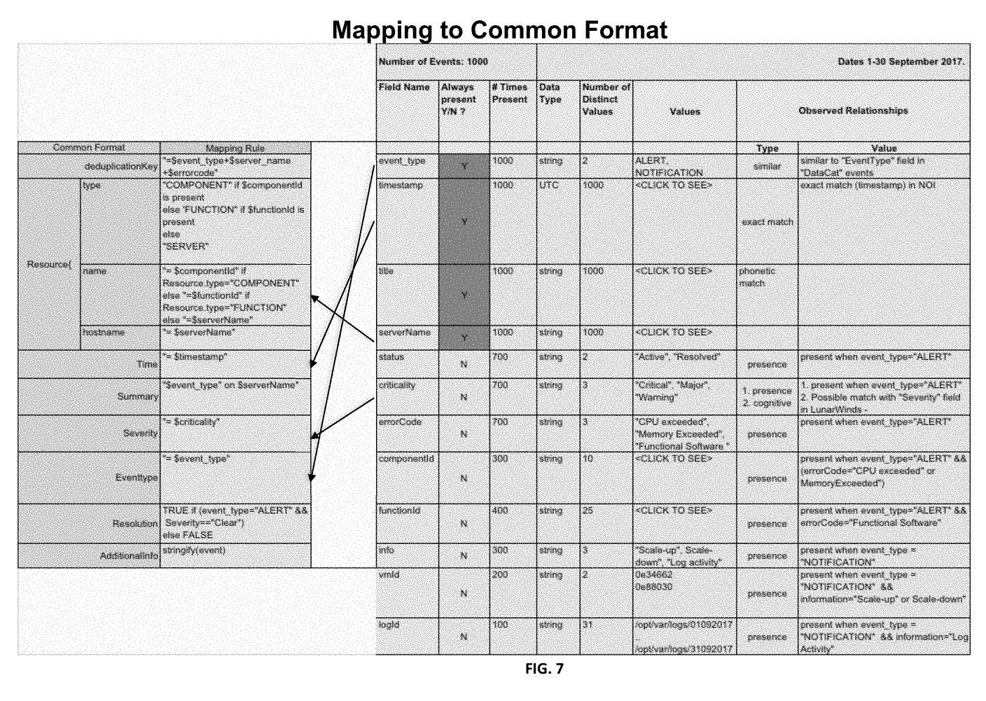

FIG. 7 illustrates the mapping of the observed relationships shown in the Observed Relationships Matrix of FIG. 5 to a predefined common format, of the illustrative example. In particular, the predefined common format comprises the fields deduplicationKey, Resource [type, name, hostname]; time; Summary; Severity, Eventtype; Resoluton; AdditionalInfo. The method of FIG. 6 determines a mapping of the events of the event source to the common format. In particular, in the illustrated example, the method determines a “mapping rule” that defines a mapping of one or more fields in events from the event source to each field of the common format, as described below.

The method 600 starts at step 605. For example, the method may start in response to the generation of the Observed Relationships Matrix, in accordance with step 290 of the method of FIG. 2.

At step 610, the method receives an Observed Relationships Matrix (or equivalent) defining observed relationships for event fields of events from the event source, and, at step 620, selects an event field from the Observed Relationships Matrix.

At step 630, the method determines a mapping rule for mapping the selected event field to a field of the common format. For example, as shown in FIG. 7, a mapping is determined between the event field timestamp and the field Time of the common format, based on the observed relationship of an exact match to the event field timestamp of events from the event source called NOI in the Observed Relationships Matrix (or, alternatively, based on the (cognitive) similarity of timestamp and Time). The mapping of other event fields to the common format may be more complex. For instance, step 620 may infer a probability of equivalence between event fields and fields of the common format. Furthermore, the mapping rule may be conditional, based on observed relationships, such as intra-event relationships between event fields (e.g. conditional on the presence of a value in another field). The mapping rule may also define an algorithm to normalize numerical values in a range of an event field to a value within a range specified by the common format. FIG. 7 illustrates the mapping of some of the event fields and fields of the common format, and associated mapping rules determined in accordance with step 630.

Step 640 determines whether there are further event fields to consider. If step 640 determines that there are further fields to consider, the method returns to step 620, which selects a next event field from the Observed Relationships Matrix. However, if step 640 determines that there are no further fields to consider, then a mapping rule has been determined for every event field, and the method proceeds to step 650.

Optional steps 650 and 660 may allow for user acceptance and/or configuration of the mappings determined in the previous steps. In particular, at step 650, the method presents the proposed mapping between event fields and fields of the common format to a user. For example, the proposed mapping may be provided on a user interface, which allows the user to accept or modify each mapping rule determined in step 630. Step 660 may receive user configuration information for the proposed mapping, accordingly. For example, the user configuration may indicate, for each mapping rule, whether the proposed mapping is accepted or should be modified. As the skilled person will appreciate, in other example implementations, steps 650 and 660 may be performed between steps 630 and 640.

At step 670, the method determines a mapping of the event fields in the superset of event fields of events for the event source to the field of the common format, for utilization in a normalizer. For example, if user configuration of the proposed mapping is received in step 660, the mapping determined in step 670 may include modified versions of the mapping rule(s) determined in step 630. However, if no user configuration is received in step 660, or if step 650 and 650 are omitted, the mapping determined in step 670 corresponds to the mapping rules determined in 630. The method then ends at step 675.

As the skilled person will appreciate, optional steps 650 and 660 allow for manual intervention by a user, to improve accuracy of the determined mapping (e.g., each mapping rule). However, manual intervention is not essential, and the mapping can be determined fully automatically. Accordingly, in some example implementations, manual intervention may not be performed and/or a user may be able to configure settings that determine whether or not manual intervention is performed.

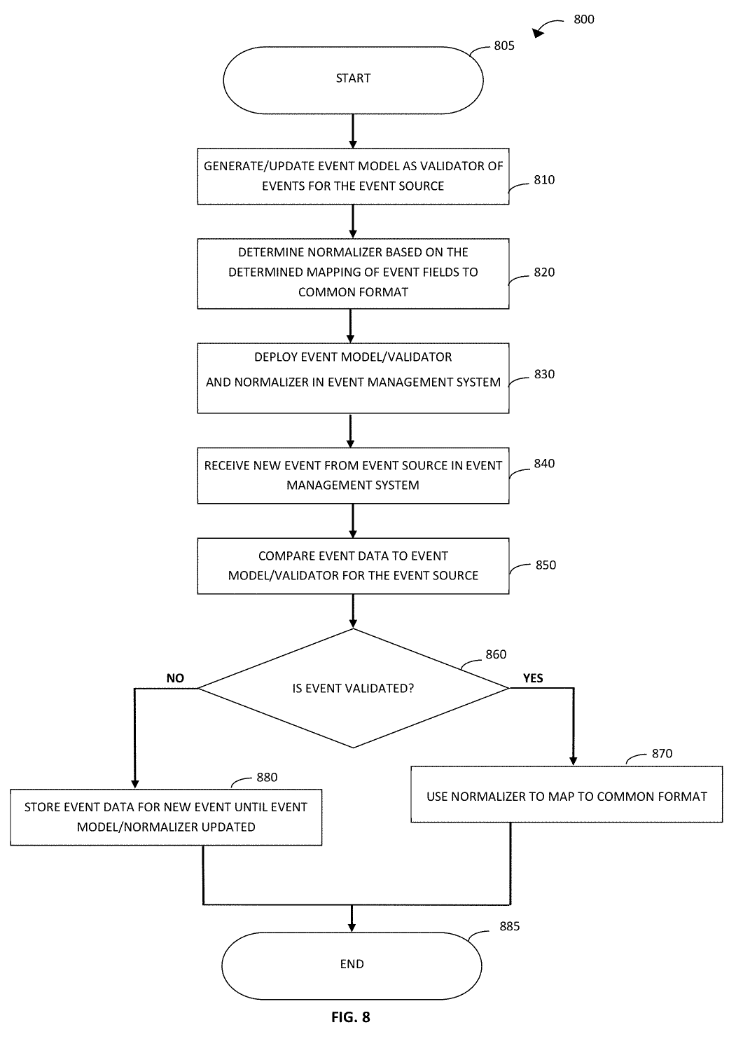

FIG. 8 is a flowchart of a method for deploying a mapping to an event management system 20 by an event learning system 30, in accordance with example implementations of the present disclosure. In particular, the method 800 of FIG. 8 may be performed in the learning mode of the event learning system 30, following the determination of the mapping in accordance with the method of FIG. 6. The method 800 of FIG. 8 deploys the mapping of event data of events for the event source 40 to the common format, for use by a normalizer 24 in the event management system 20. It will be appreciated that the method 800 of FIG. 8 may also be performed in the second, updating mode and the third, early deployment mode of the event learning system 30, to deploy an updated or initial mapping, respectively, for implementation in the normalizer 24 for the corresponding event source 40, as described below. The method 800 of FIG. 8 also includes utilization of the deployed mapping/normalizer 24 in the event management system 20 in accordance with example implementations.

The method 800 starts at step 805. For example, the method 800 may start in response to a manual user action requesting or initiating deployment of a normalizer 24 for a new event source, or automatically, for example in response to the determination of a mapping in step 670 of the method 600 of FIG. 6.

At step 810, the method generates or updates an event model for events of the event source, for use as a validator. The event model may comprise at least the superset of event fields, and may include observed relationships, such as relationships (e.g., frequency of occurrence, dependencies etc.) between fields including relationships between anchor fields, and optionally sub-anchor fields, and other event fields, for example as determined in the Observed Relationships Matrix illustrated in FIG. 5.

At step 820, the method determines a normalizer based on the determined mapping of event fields of events from the event source to fields of a predefined common format. In particular, a normalizer is determined for implementing the mapping. For example, the normalizer may comprise a module, process or algorithm for mapping each event field of an event from the event source to a field of the common format, using the associated mapping rule(s).

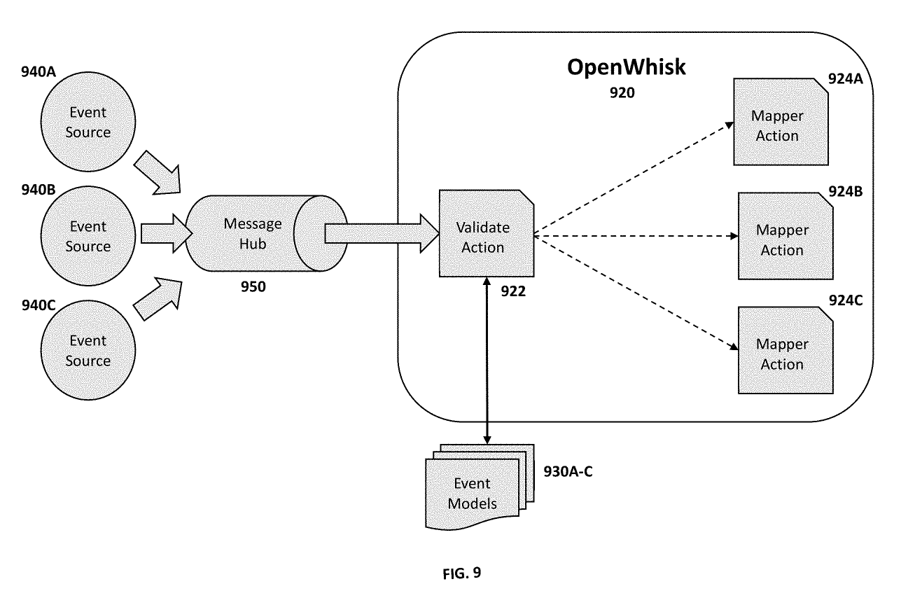

Step 830 deploys the event model and normalizer for the event source. For example, the event model and normalizer may be uploaded from the event learning system to the event management system, and stored in memory. One exemplary technique for deployment is illustrated in FIG. 9 and uses the open source cloud platform “Apache OpenWhisk” (herein simply called “OpenWhisk”) for fast and scalable deployment, as described below.

FIG. 9 is a schematic diagram of an event management system 920, in which the event model and normalizer are deployed on an OpenWhisk platform. As well known to the skilled person, the OpenWhisk platform provides a set of “rules”, which are implemented by “validators” or “triggers”, and a set of “actions” that are performed on validated inputs to produce output results. Accordingly, the event management system 920 of FIG. 9 receives events from multiple event sources 940A-C via a message hub 950. Each event is then validated by a validator 922 in a “validate action” using the appropriate event model 930A-C for the event source 940A-C. The appropriate event model 930A-C used by the validator 922 may be determined from an identifier of the event source 940A-C or event source type in a header of an event message containing the event data in its payload, or otherwise. Once validated, the event is forwarded to a corresponding normalizer or “event mapper” 924A-C to perform the corresponding normalization or “mapper action”. The mapper action maps or normalizes and outputs the event according to the predefined common format. In some example implementations, one or more of the event models 930A-C are defined in JavaScript™ as the JSON schema for the corresponding expected JSON formatted event. Each event attribute is labelled as required from mandatory fields within the corresponding event mapper. The event model 930A-C is used by the validator 922 in the event management system 920, and validates each incoming JSON event from the corresponding event source 940A-C before normalization (Java and all Java-based trademarks and logos are trademarks or registered trademarks of Oracle and/or its affiliates).

As the skilled person will appreciate, the event management system 920 includes an event model 930A-C for the validator to use for each event source 940A-C. Thus, the validate action of FIG. 9 involves identifying the corresponding event model 930A-C for an incoming JSON event. Upon successfully validation of an incoming JSON event by a validator, the event data is automatically routed to the corresponding normalizer/event mapper to perform the “mapper action”. In other implementations, a separate validator 922 may be provided for each event source 940A-C, and event messages may be routed to the appropriate validator, for example by message hub 950.

In example implementations, step 830 deploys the event model/validator to the event management system using OpenWhisk before deployment of the corresponding event mapper/normalizer. In this way, incoming events can be validated by a new event model/validator and held in memory, until the event mapper/normalizer is available to perform the corresponding mapper action. This enables faster and more efficient deployment.

Returning to FIG. 8, subsequent steps 840 to 880 are method steps implemented in the event management system, in which the mapping for the event source is deployed in a normalizer in step 830. In particular, a new event is received from the event source at step 840, and the event data is compared to the event model by the validator at step 850. Step 860 considers whether or not the event is validated. If step 860 determines that the event is validated, the method proceeds to step 870, which forwards the event to the corresponding normalizer to map the event to the common format and may store the formatted event, accordingly. The method then ends at step 885. Thus, step 840 to 870 correspond to the “validate action” of the validator, as described above with reference to FIG. 9. However, if step 860 determines that the event is not validated, the method proceeds to step 880. Step 880 may store the event data for the new event for further processing, for example when the event model/normalizer is updated to enable processing of the corresponding event type. Step 880 may also send a notification to the event learning system and/or an operator to indicate that the event management system was unable to process the new event. The method then ends at step 885.

As described above, in a learning mode of operation, the event learning system 30 of FIG. 1 performs event learning based on a set of events received form an event source 40, in accordance with the method FIG. 2. The event learning system 30 determines a mapping of the events to a common format, in accordance with the method of FIG. 6. The determined mapping is then deployed as a normalizer 24 in the event management system 20 of FIG. 1.

In example implementations of the present disclosure, “event learning” may continue after deployment of the normalizer 24 by the event learning system 30 in the learning mode of operation. In particular, as shown in FIG. 1, the event learning system 30 may continue to receive events from the event source 40, following deployment of a normalizer 24 in the event management system 20 in a second, “updating” mode of operation. In the updating mode of operation, the event learning system 30 repeats some or all of the steps performed in the learning mode of operation, by receiving and analyzing new events or sets of events received from the event source, updating the mapping to the common format and redeploying a normalizer 24 with the updated mapping, when called for or indicated by the analysis. The event learning system 30 may operate in the updating mode of operation continuously, periodically, in response to a triggering message or otherwise, according to application requirements. For example, the event learning system 30 may operate in the “updating mode”, and so perform analysis of new events from the event source, in response to receiving a single new event from the event source, receiving a predetermined number of new events from the event source or at predetermined time intervals. In addition, or alternatively, the event learning system 30 may operate in the “updating mode”, in response to a triggering message, which may be sent manually or automatically. For example, an automatic triggering message may be received by the event learning system 30, in response to the event management system 20 identifying and/or storing an event, which the existing normalizer is unable to validate, as in step 880 of the method of FIG. 8. A manual triggering message may be received from a user of the user interface 60 of the event management system 20.

The operation of the event learning system 30 in a continuous or periodic loop in the “updating mode” enables more accurate and consistent mapping of events from the event source to the common format, in particular including a mapping for rarely occurring events, which may not appear in the original event set in the learning mode. Furthermore, updating of the normalizer 24 in the event management system 20 enables stored historic events from the event source 40, which could not be validated by the normalizer in use at the time, to be processed and reported to the user.

In accordance with example implementations of another aspect of the present disclosure, the event learning system 30 of FIG. 1 may operate in a third, “early deployment” mode. In the early deployment mode of operation, event learning in accordance with the learning mode is curtailed or truncated. In particular, an initial mapping to the common format may be determined and generated, and a corresponding normalizer deployed, based on a limited number of events such as just a single received event. In some example implementations, the initial mapping may be determined using event learning as described above in relation to the learning mode. For example, the initial mapping may be determined using iterative intra-event analysis as described above. In other example implementations, more simplified event learning techniques may be employed. For example, the initial mapping may be determined using inter-event source analysis as described above, without performing intra-event analysis. All suitable techniques for determining the initial event mapping to the common format, whether based on event learning or otherwise, are possible and contemplated by the present disclosure.

Following the deployment of a normalizer based on the initial mapping in accordance with the early deployment mode, the event learning system 30 continues to update the mapping and corresponding normalizer in the updating mode, using the techniques described above in relation to the learning mode. In particular, the event learning system 30 repeats the steps performed in the learning mode of operation, by receiving and analyzing new events or sets of events received from the event source, updating the initial mapping to the common format and redeploying a normalizer 24 with the updated mapping, when called for by the analysis. The event learning system 30 may continue with such updating, following early deployment of an initial normalizer in the early deployment mode, continuously, periodically, upon user request, in response to a triggering message or otherwise, according to application requirements.

The use of the “early deployment” mode of the event learning system 30 enables new event sources to be connected to provide events to an event management system 20 more quickly, for example using the abovementioned “Open Whisk” platform. Thus, new monitored systems 42 can be quickly brought into service by an enterprise, and managed within an existing event management system 20, such as a so-called “operations management system” functioning as a “manager of managers” of the enterprise, without the delays associated with existing techniques that require the development of a robust normalizer for a new event source of with a new system, before new systems are brought into service. An accurate and robust normalizer is developed for the new event source whilst it is in service, using the “updating mode” as described above.

Accordingly, the present disclosure provides systems, methods and computer program products for efficiently analyzing events from an event source using machine learning techniques comprising event learning, intra-event analysis and inter-event source analysis, determining a mapping of the events to a common format, and implementing the mapping in an event management system. Example implementations enable continual event learning, by analyzing new events from the event source, and adaptation of the mapping accordingly, to improve the accuracy and robustness of the mapping. Importantly, in example implementations, the analysis of at least some of the events include analyzing the frequency of occurrence and other relationships between identified potential ‘key’ fields to other fields in the events, to identify predetermined types of relationships that occur in, and are important for, event management. Examples of such key fields are indicated below. Potential key fields in events from an event source found to exhibit such predetermined types of relationships with other fields, can therefore be accurately mapped to the appropriate field of the common format, thereby further improving the accuracy and robustness of the mapping. Thus, in accordance with the present disclosure, an accurate and robust normalizer, that maps events from an event source to a common format, may be developed automatically, or at least semi-automatically, thus avoiding the delays associated with conventional manual techniques for developing a normalizer.

One of the issues of providing a robust mapping of events to a common format, is how the mapping deals with how events are “resolved”. This corresponds to the “Resolution” field in common format shown in FIG. 7. Typically, when a problem occurs, one or more events of the event type “ALERT” are generated by an event source. In response, the event management system typically creates an “incident” that indicates to an operator that there is something within the system monitored by the event source that requires attention and needs to be fixed (e.g. a component is not operating correctly and needs to be replaced). When that problem is fixed, a similar set of “ALERT” events are generated by the event source, but this time, indicating that the incident is now resolved. Another issue that is particular to event management systems is how event are “de-duplicated”. De-duplication is needed in event management systems so that the operator is not presented with more than one ‘event’ or ‘incident’ for the same problem. Usually a combination of fields within the event determines this ‘deduplicationKey’, as defined in the common format shown in FIG. 7. Other important fields in event management systems, for which accurate mapping must be provided, include “severity” and “resource” (i.e., the resource that has the problem).

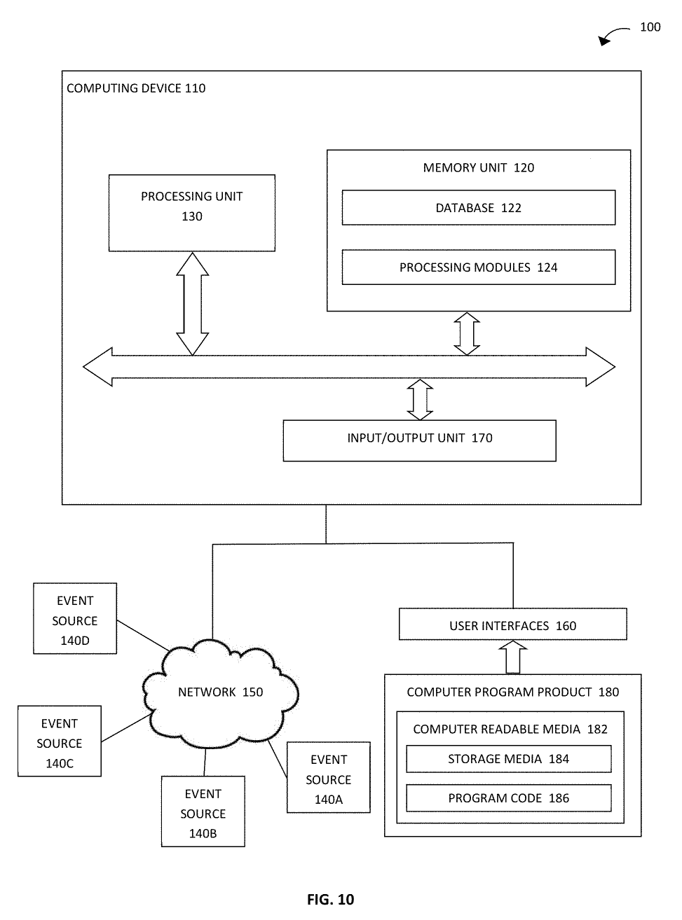

FIG. 10 is a block diagram of a computing system 100 in accordance with example implementations of the present disclosure. In particular, the computing system 100 may comprise the event management system 20 or the event learning system 30 of FIG. 1. In some example implementations, the event management system 20 and the event learning system 30 may be combined in single computing system 100. In other example implementations, the event management system 20 and/or the event learning system 30 may be arranged in a distributed computing system 100.

As shown in FIG. 10, the computing system 100 comprises a computing device 110 (or other similar data processing device) having a memory unit 120, a processing unit 130 and an input/output unit 170. Computing device 110 further includes user interface devices 160 connected to input/output unit 170 or integrated within computing device 110. User interface devices 160 may include one or more of a display (e.g., screen or touchscreen), a printer, a keyboard, a pointing device (e.g., mouse, joystick, touchpad), an audio device (e.g. microphone and/or speaker) and any other type of user interface device. Input/output (I/O) unit 170 is connected to a data communications network 150 to send and receive data to and from other computing devices connected to the network 150. In particular, I/O unit 170 is configured to receive event messages from one or more event sources 140A-D over the network 150, and/or to send or receive one or more triggering messages to initiate the updating mode of an event learning system, as described above. Network 150 may comprise any suitable wired or wireless data communications network, such as a local area network, wide area network or the Internet.

Memory unit 120 of computing device 110 may include databases 122, for storing data in accordance with the present disclosure. In example implementations in which the computing device 110 comprises the event learning system 30 of FIG. 1, databases 122 may include an events database 34 and a mapped events database 28. In example implementations in which the computing device 110 comprises the event management system 20 of FIG. 1, databases 122 may include a mapped events database 28.

Memory unit 120 of computing device 110 may also include processing modules 124, for implementing steps of one or more of the methods of example implementations of the present disclosure. Each processing module 124 comprises instructions for execution by processing unit 130 for processing data and/or instructions received from input/output unit 170 and/or data and/or instructions stored in memory unit 120. In example implementations in which the computing device 110 comprises the event learning system, processing modules 124 may include an event analysis module for analyzing events from an event source, as in the method of FIG. 2 for example, an event mapping module for determining a mapping of events from the event source to a common format, as in the method of FIG. 6 for example, and a mapping deployment module for deploying a normalizer in accordance with the mapping, as in steps 810 to 830 of the method of FIG. 8 for example. In example implementations in which the computing device 110 comprises the event management system of FIG. 2, processing modules 124 may include an event validation module for validating received events in accordance with a normalizer, as in steps 840 to 880 of the method of FIG. 8 and an event mapping module for mapping a validated event to a common format, as in step 870 of the method of FIG. 8.

In example implementations of the present disclosure, a computer program product 190 may be provided, as shown in FIG. 10. The computer program product 180 may include computer readable media 182 having storage media 184 and program instructions 186 (i.e., program code) embodied therewith. The program instructions 186 may be loaded onto memory unit 120 of computing device 110 via I/O unit 170, for example by one of user interface devices 160. The program instructions 186 may comprise one or more of the above described processing modules 124.

Whilst the present disclosure has been described and illustrated with reference to example implementations, the skilled person will appreciate that the present disclosure lends itself to many different variations and modifications not specifically illustrated herein.

The present disclosure encompasses a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some example implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to example implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various example implementations of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various example implementations of the present disclosure have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the example implementations, the practical application or technical improvement over technologies found in the marketplace, or to enable others of ordinary skill in the art to understand the implementations disclosed herein.

What is claimed is:

1. A method comprising:
receiving a plurality of events from an event source, each event comprising event data relating to a monitored system associated with the event source;
identifying a set of data fields in the event data of the plurality of events;
determining one or more relationships between at least one data field in the set of data fields and at least one other data field in the set of data fields, and
determining a mapping of the event data of the plurality of events to a predefined common format, based on the one or more relationships.

2. The method of claim 1, further comprising:
identifying an anchor field in the identified set of data fields, wherein the anchor field has a high frequency of occurrence in the plurality of events and has a relatively small number of distinct values greater than one, and
analyzing the events to determine relationships between the anchor field and at least one other data field in the set of data fields.

3. The method of claim 2, wherein analyzing the events identifies one or more sub-anchor fields of the anchor field, wherein each sub-anchor field is present in all the events in the plurality of events when the anchor field has a particular value.

4. The method of claim 3, wherein determining one or more relationships between at least one data field in the set of data fields and at least one other data field in the set of data fields comprises:
determining a condition that defines the relationship between each sub-anchor field and the anchor field in the set of data fields.

5. The method of claim 2, wherein analyzing the events is performed iteratively until all relationships between each data field and the other data fields in the set of data fields are determined.

6. The method of claim 1, further comprising:
comparing at least one data field in the set of data fields for the plurality of events with data fields in a set of data fields for events provided by another event source to determine one or more relationships between data fields for the plurality of events and data fields for events provided by the other event source.

7. The method of claim 6, wherein the comparing determines one or more relationships selected from the group consisting of:
an exact match between the names or values of fields and their relationships;
a similarity between the names or values of fields and their relationships, and
a cognitive match between names or values of fields and their relationships, including a match in meaning of the names or values or the phonetic or translated equivalents thereof.

8. The method of claim 1, further comprising:
determining one or more relationships between at least one data field in the set of data fields and at least one data field of the predefined common format, and
comparing determined relationships between at least one data field in the set of data fields and at least one data field of the predefined common format with known relationships between data fields of events provided by another event source and the data fields of the predefined common format.

9. The method of claim 1, wherein determining a mapping of the event data of the plurality of events to a predefined common format, based on the determined one or more relationships, comprises:
determining a mapping rule, for mapping data of a data field to a corresponding data field of the predefined common format.

10. The method of claim 1, further comprising:
deploying a normalizer in an event management system, wherein the normalizer is configured to implement the determined mapping of the event data of the plurality of events to the predefined common format for events received by the event management system from the event source.

11. The method of claim 10, further comprising:
determining an event model of events received from the event source, and
deploying a validator in the event management system, wherein the validator is configured to validate events received by the event management system from the event source, wherein:
if a received event from the event source is validated, the validator forwards the event data for the received event to the normalizer, or
if a received event from the event source is not validated, the validator stores the event data in memory and issues a notification indicating that the event model and/or normalizer requires updating.

12. The method of claim 10, further comprising:
receiving at least one new event from the event source;
identifying new fields in the set of data fields in the event data, based on the at least one new event from the event source;
analyzing the at least one new event, to determine one or more relationships selected from the group consisting of: relationships between at least one data field and at least one other data field in the new event, and relationships between at least one data field in the new event and at least one data field of the predefined common format, and
updating the determined mapping of the event data of events from the event source to the predefined common format, based on the analysis.

13. An apparatus comprising:
an event learning system comprising a processor and memory, wherein the processor is configured to:
receive a plurality of events from an event source, each event comprising event data relating to a monitored system associated with the event source;
identify a set of data fields in the event data of the plurality of events;
determine one or more relationships between at least one data field in the set of data fields and at least one other data field in the set of data fields, and
determine a mapping of the event data of the plurality of events to a predefined common format, based on the determined one or more relationships.

14. The apparatus of claim 13, wherein the processor is further configured to:
identify an anchor field in the identified set of data fields, wherein the anchor field has a high frequency of occurrence in the plurality of events and has a relatively small number of distinct values greater than one, and
analyze the events to determine relationships between the anchor field and at least one other data field in the set of data fields.

15. The apparatus of claim 14, wherein analyzing the events identifies one or more sub-anchor fields of the anchor field, wherein each sub-anchor field is present in all the events in the plurality of events when the anchor field has a particular value, wherein the processor is further configured to:
determine a condition that defines the relationship between each sub-anchor field and the anchor field in the set of data fields.

16. The apparatus of claim 14, wherein the processor is further configured to:
analyze the events iteratively until all relationships between each data field and the other data fields in the set of data fields are determined.

17. The apparatus of claim 13, wherein the processor is further configured to:
compare at least one data field in the set of data fields for the plurality of events with data fields in a set of data fields for events provided by another event source to determine one or more relationships between data fields for the plurality of events and data fields for events for events provided by the other event source.

18. The apparatus of claim 17, wherein the processor is configured to determine one or more relationships between data fields for the plurality of events and data fields for events provided by the other event source selected from the group consisting of:
an exact match between the names or values of fields and their relationships;
a similarity between the names or values of fields and their relationships, and
a cognitive match between names or values of fields and their relationships, including a match in meaning of the names or values or the phonetic or translated equivalents thereof.

19. The apparatus of claim 13, wherein the processor is further configured to:
determine one or more relationships between at least one data field in the set of data fields and at least one data field of the predefined common format, and
compare determined relationships between at least one data field in the set of data fields and at least one data field of the predefined common format with known relationships between data fields of events provided by another event source and the data fields of the predefined common format.

20. A computer program product comprising a computer readable storage medium having program instructions embodied therewith, wherein the program instructions are executable by a processor to cause the processor to:
receive a plurality of events from an event source, each event comprising event data relating to a monitored system associated with the event source;
identify a set of data fields in the event data of the plurality of events;
determine one or more relationships between at least one data field in the set of data fields and at least one other data field in the set of data fields, and
determine a mapping of the event data of the plurality of events to a predefined common format, based on the determined one or more relationships.
